(19) United States
(12) Patent Application Publication
(10) Pub. No.: US 2022/0129919 A1
(43) Pub. Date: Apr. 28, 2022

(54) AUTOMATED SHOPPING ASSISTANT CUSTOMIZED FROM PRIOR SHOPPING PATTERNS

(71) Applicant: Toshiba TEC Kabushiki Kaisha, Shinagawa-ku (JP)

(72) Inventors: Jia ZHANG, Irvine, CA (US); Christopher NGUYEN, Huntington Beach, CA (US)

(21) Appl. No.: 17/079,920

(22) Filed: Oct. 26, 2020

(51) Int. Cl. G06Q 30/02; G06Q 30/06

(52) U.S. Cl. CPC G06Q 30/0201; G06Q 30/0239; G06Q 30/0639

(57) ABSTRACT

A system and method for generating a customized shopping assistant map on a smartphone or tablet is generated in accordance with a retail consumer's identity determined from facial recognition. Information from content and timing of a customer's prior product purchases is analyzed via application of machine learning, and the consumer's shopping patterns are established. When the consumer enters a retail location, their face is recognized and frequently purchased products and their location at the current store is generated on their device, along with information including relevant coupons or on-sale items.

### TECHNICAL FIELD

This application relates generally to a system and method to provide automated shopping assistance to shoppers based on their historic shopping choices.

### BACKGROUND

While mail order purchases are on the rise, many products are still purchased by consumers at a retail premises. This is especially the case for perishable items, such as groceries, as well as clothing, which customers still like to try on for fitting and viewing prior to purchasing.

Consumers often shop at the same store, or different branches for the same store. In the case of consumables, such as groceries, shoppers generally know the location goods from their usual store location which they buy frequently. However, if they go to a different location, they can spend considerable time trying to locate items on their list, and they may have to retrace their steps multiple times to track down missing items. One solution is to try to track down a store employee to ask for a product location. When many items cannot be found, an employee may have to found multiple times during a single shopping trip. This problem can be further exacerbated understanding that many store workers are not employed by the establishment, but provide direct stocking of products they deliver to the store. They are likely unknowledgeable about locations of any goods but their own. Even when a consumer shops at their customary location, stores often rearrange their inventory, and the same problems can occur.

### BRIEF DESCRIPTION OF THE DRAWINGS

Various embodiments will become better understood with regard to the following description, appended claims and accompanying drawings wherein:

FIG. 1 is an example embodiment of an automated shopping system that is customized from prior shopping patterns;

FIG. 2 is an example embodiment of a shopper's portable data device;

FIG. 3 is an example embodiment of a digital device system;

FIG. 4 is an example embodiment of an automated custom shopper assistant system;

FIG. 5 is an example embodiment of a process for operation of an automated, customized shopping assistant;

FIG. 6 is a hardware block diagram of an example embodiment of an automated, customized shopping assistant;

FIG. 7 is an software block diagram of an example embodiment of a customized shopping assistant; and

FIG. 8 is an example embodiment of a customized shopping assistant.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In example embodiments herein provide an automatic assistant system which helps consumer with shopping based on their own prior shopping patterns. Most consumers have their developed their own shopping patterns over time. For example, a consumer may shop for their family on a weekly basis for the essential items such as milk, eggs, fruits, and meats. They may have alternative shopping patterns at the same time. For example, the consumer may shop for laundry detergent every couple of months.

In an example embodiment, a retail store system keeps a record of consumers' faces and a list of their shopping items and purchasing intervals and identifies one or more shopping patterns for each consumer. This information can be shared among affiliated stores. When the same consumer enters a store, the system identifies the consumer and sends a store map including an indication of a current location of their frequently purchased items or items that are due for repurchase based on their shopping pattern. Information is sent to the consumer's smart device, such as smartphone or tablet, by identification accomplished by facial recognition. If the consumer enters a different store branch the consumer can easily locate products that are often purchased as their locations at the new store have been identified and indicated on their map.

When the consumer shops at the same store frequently, and knows the typical location of the products, the retailer store often times will update the shelf space for products. With the subject system, the consumer does not need to worry about locating their frequent purchased products when they have been relocated.

In further example embodiments, the system includes a reminder subsystem that reminds the consumer to buy certain products based on the shopping pattern. In the example above, it may have been two months since their last laundry detergent purchase, and they may not have recalled that it's time to replenish their supply.

Example embodiments identify and utilize individual consumer shopping pattern, and through the use of a recommendation engine, the retailer store is able to push on-sale information and/or coupons to consumer's smart phone for potential products of interest.

Retailer store is able to keep a record of the consumer's face and shopping item list, and compile a shopping pattern for the consumer.

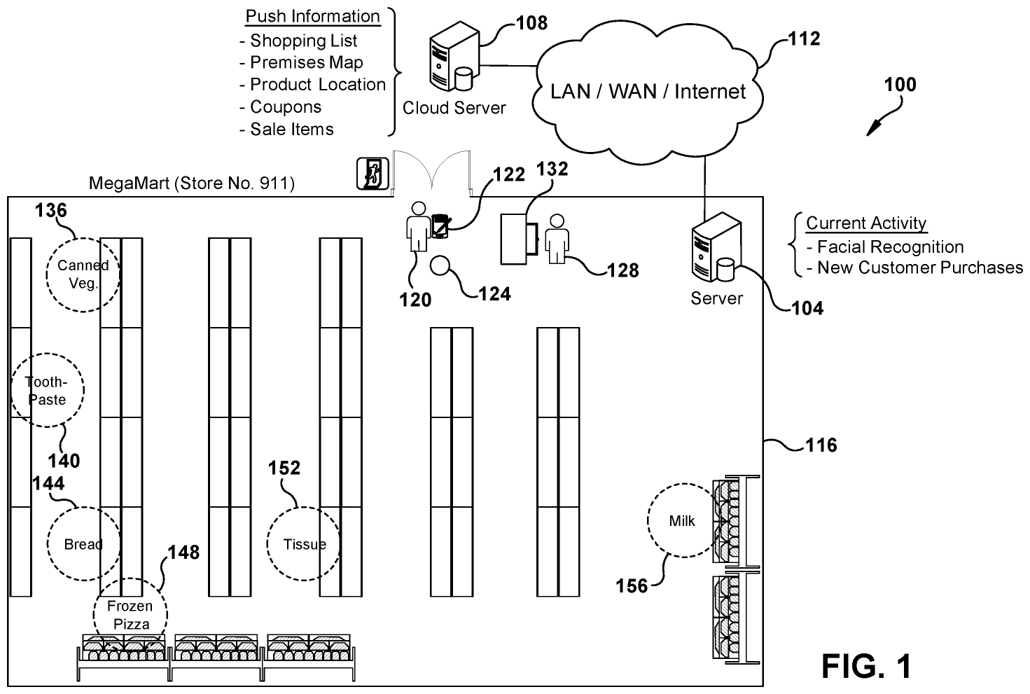

In accordance with the subject application, FIG. 1 illustrates an example embodiment of an automated shopping system 100 that is customized from prior shopping patterns. One or more servers, such as server 104 and cloud server 108 are in network communication with network cloud 112, suitably comprised of any wireless or wired local area network (LAN) or a wide area network (WAN) which can comprise the Internet, or any suitable combination thereof. In the illustrated example, server 104 is associated with retail premises 116 for MegaMart store no. 911. Consumer 120 has a personal, portable data device 122, suitably comprised of a smartphone, tablet computer, or the like. When a consumer enters premises 116, illustrated as MegaMart Store No. 911) their facial image is captured by digital camera 124. Consumers' facial images are associated with contact information, such as their name, email address, cellphone number, Internet protocol (IP) address, or the like. Such information is suitably stored on suitable device or devices such as server 104 or cloud server 108. Shopping pattern information or data is also stored associatively with each consumers' facial and contact information.

During a shopping visit, consumers acquire their selection of goods from the premises and pay for their selections when they leave, such as via clerk 128 at checkout point-of-sale (POS) terminal 132. Their selections are stored associatively a purchase date with their shopping pattern information. In the illustrated example, consumer 120 purchases canned vegetables from location 136, toothpaste from location 140, bread from location 144, frozen pizza from location 148, tissue from location 152 and milk from location 156. This information is aggregated with information from prior shopping visits for consumer 120 if this is not their initial visit using the assistant. The system 100 includes pre-stored information or data indicating a location at the premises for each item selected for purchase. If consumer 120 has an established shopping pattern when they are identified as they enter the premises 116, a store map showing locations for frequently purchased items, or items that are likely due for repurchase, is generated and sent to the user's device 122 before they start shopping. A suitable map may appear similar to the layout and indications illustrated in FIG. 1. As will be detailed further below, the system 100 further stores information relative to on-sale items and store coupons, such as electronic coupons. A determination is made as to which on-sale items or coupons correspond to a consumer's shopping pattern, and these are made available to the consumer 120 on their device 122 as they shop.

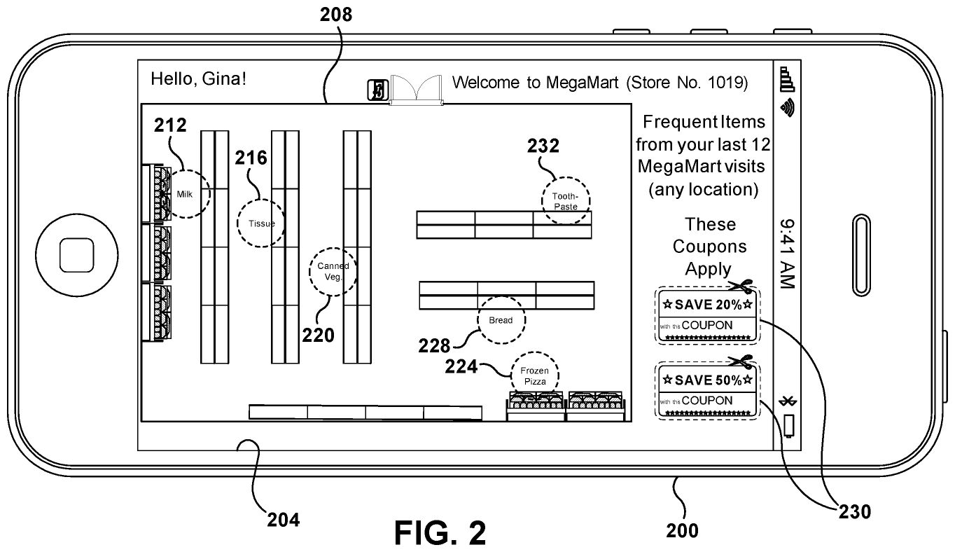

FIG. 2 is an example embodiment of a shopper's portable data device, illustrated as smartphone 200 which includes touchscreen display 204. In the example, a shopper (consumer 120 from FIG. 1) associated with smartphone 200 has entered MegaMart store no. 1019, a different branch of the store to that of FIG. 1. A map 208 is generated for the consumer based on their identity gleaned from facial recognition and their established shopping patterns. It will be noted that a floorplan of the generated map differs from that of MegaMart store no. 911 from FIG. 1. However, insofar as related or affiliated stores typically carry the same or similar items, goods from the consumer's shopping patterns are generally available from the new location. In the illustration, goods from the store layout of FIG. 1 are available, albeit in different locations. These include milk at location 212, tissue at location 216, canned vegetables at location 220, frozen pizza at location 224, bread at location 228, and toothpaste at location 232. The assistant therefore provides consumer ease to locate items likely to be of interest. Coupons 230 associated with one or more of those items can be presented and applied using the touchscreen display 204.

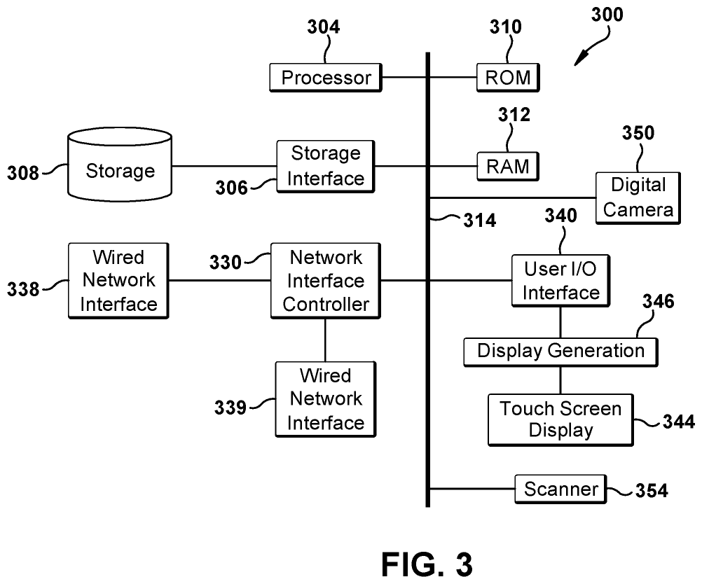

Turning now to FIG. 3, illustrated is an example of a digital device system 300 suitably comprising servers 104 and 108 of FIG. 1, as well as a portable data device such as a smartphone or tablet, such as portable data device 122 of FIG. 1 and smartphone 200 of FIG. 2. The system may also comprise a POS terminal such as POS terminal 132 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338 or a wired data connection via wired network interface 339. A suitable data connection to an MFP or server is via a data network, such as a local area network (LAN), a wide area network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform. Processor 304 is also in data communication with a digital camera 350, which may be from an external device, such as camera 124 of FIG. 1, or integrated into a smartphone or tablet computer. Processor 304 is also suitably in data communication with a scanner 354, which may comprise a barcode scanner such as one used a POS terminal or integrated into a digital camera in a smartphone or tablet computer.

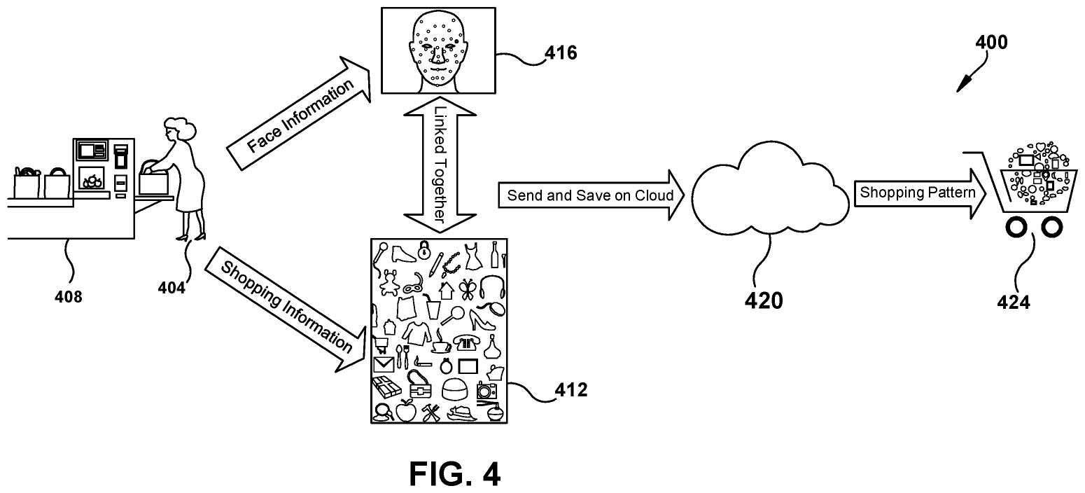

FIG. 4 is an overview diagram of an example embodiment of an automated custom shopper assistant system 400. In the illustration, shopper 404 supplies information relative to their purchases when checking out at POS terminal 408. The consumer thus supplies shopping information 412 as well as a digital face image capture 416 as they engage the system 400. This information is sent to a cloud service 420 which aggregates information to establish shopping pattern data 424 for the shopper 404.

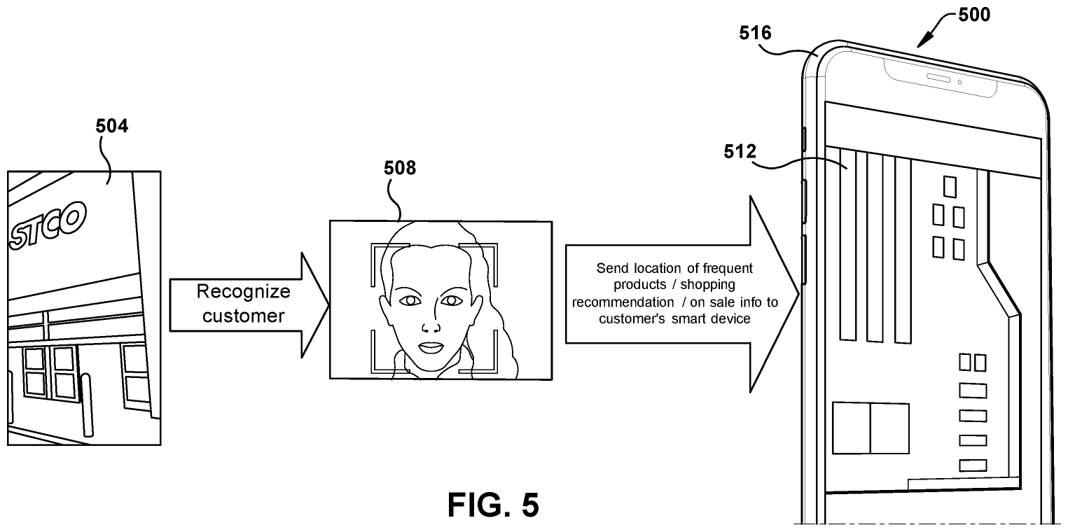

FIG. 5 is an overview diagram 500 of an overall process for operation of an automated, customized shopping assistant. When a consumer enters a retail premises 504, facial image 508 is captured and used to identify a shopper. Once identified, information including a location of frequently purchased goods at that store, along with purchase recommendations, on-sale items or coupons is assembled for the shopper to generated map display 512 on smartphone 516.

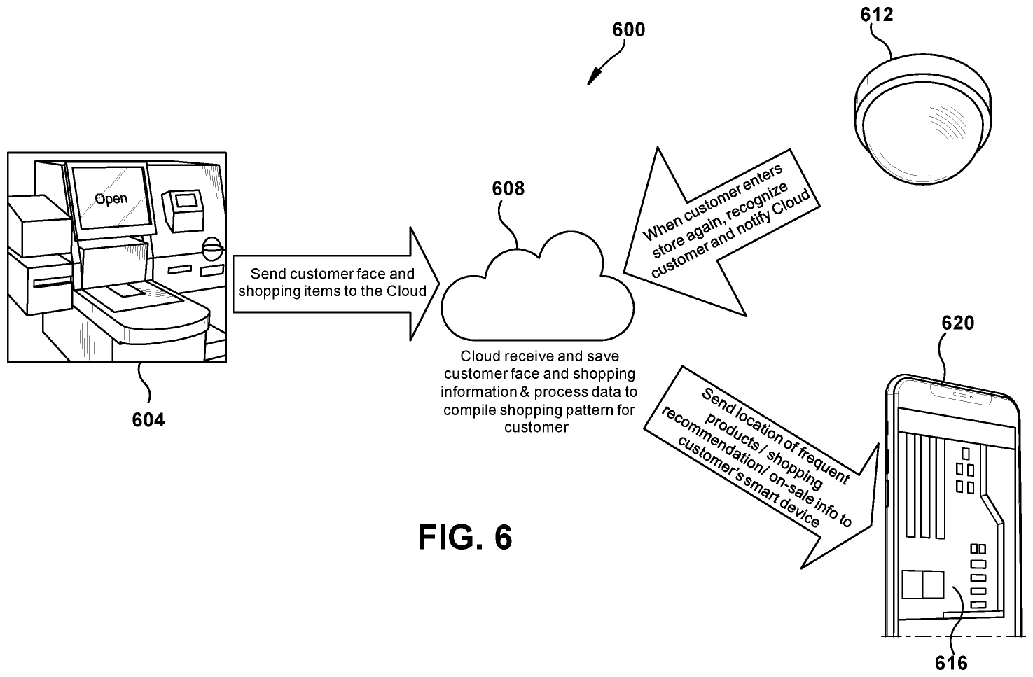

FIG. 6 is a hardware block diagram 600 of an example embodiment of an automated, customized shopping assistant. In the illustrated example, a customer checks out at POS terminal 604 that includes an associated digital camera 612. When checking out, a digital image of the customer is captured and used to access or establish a customized shopping assistant for the user. Contact information may be supplied by customer who wish to use the system directly, or via information gleaned from a credit card, debit card or check used to complete their purchase. Once established, a digital facial image as well as shopping information is sent to cloud service 608 to establish or update their shopping pattern or patterns. When the consumer re-enters the store, or enters an affiliated store, their facial image is captured and sent to cloud service 608. The customer's identity is determined, and information relative to that store, their frequently purchased items is associated with product locations for that store, and map 616 is sent to their device, such as smartphone 620 for display. Information is suitably sent to their device via text message or via email, which information may be by a supplied link or information displayable by an associated app running on their device. Alternatively, information may be supplied by any suitable wireless or wired system, including near-filed communication (NFC), Bluetooth, Wi-Fi, including Wi-Fi direct, cellular data and the like.

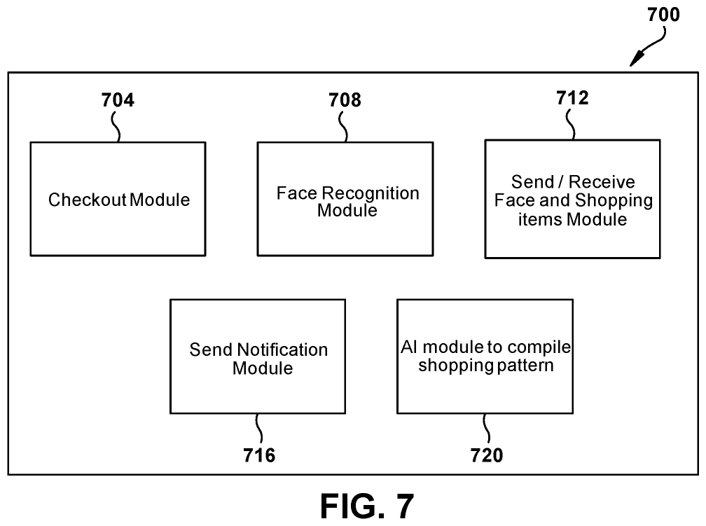

FIG. 7 is a software block diagram 700 of an example embodiment of a customized shopping assistant. Included is checkout module 704, suitably comprising a POS terminal. Also included is facial recognition module 708, communication module 712 that comprises communication of facial image data and purchased item information. A send notification module 716 suitably communicates digital image data to a shopper's data device for display. Module 720 provides artificial intelligence or machine learning to received shopper information, including items purchased, dates items were purchased, quantities of items purchased, locations of items purchased, and the like to generate one or more customized patterns for each identified shopper. Machine learning is suitably applied to available information via a server, such as cloud server 108 of FIG. 1. Any suitable machine learning platform may be used, such as TensorFlow, Google Cloud ML Engine, Accord.net, Shogun, or the like.

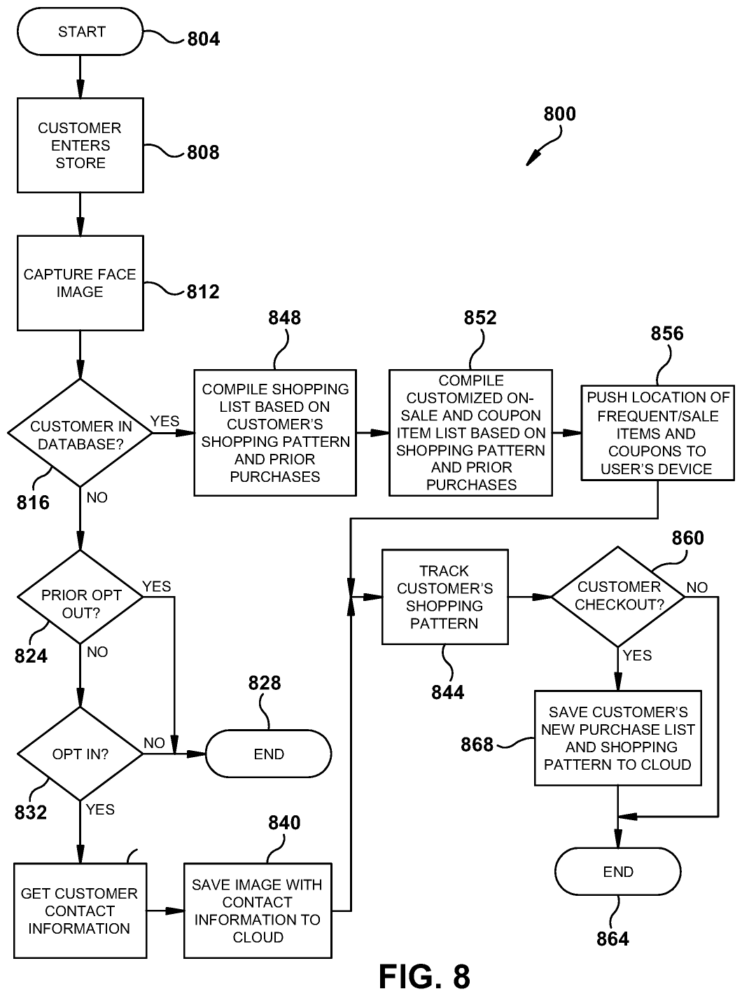

FIG. 8 is a flowchart 800 of an example embodiment of a customized shopping assistant. The process commences at block 804, and proceeds to block 808 where a customer enters a store. A facial image is captured by a digital camera at block 812, and a determination is made at block 816 as to whether a consumer can be identified as a customer in an associated database. At block 824, a check is made to determine if the customer has previously opted out. If so, the process ends at block 828. If not, customer may opt in or out of the system at block 832. If they opt out, the process ends at block 828. If they opt in, customer contact information is received at block 836 and saved, along with facial image data, at a cloud service at block 840. The customer's shopping patterns are tracked next at block 844.

If a determination is made at block 816 that an identified customer exists in the database, the process proceeds to block 848 wherein a generated shopping patterns for the customer are compiled based on their shopping patterns and prior purchases. A customized listing of coupons or on-sale items is generated from a database of coupon or on-sale items at block 852. Next, at block 856 map information, suitably including locations and listings of frequently purchased items for a current store location, is pushed to the shopper's device, along with relevant coupon or on-sale information, for display on the shopper's device. The process then proceeds to block 844.

In block 844, a customer's shopping pattern is tracked. If the customer never checks out, such as when they leave the store without any purchases, as determined by block 860, the process ends at block 864, suitably after a set timeout duration. When a customer checks out, their new purchase information and shopping pattern information is sent to the cloud service at block 868 and the process ends at block 864.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a memory storing map data corresponding to a layout of a retail premises and product placement within the retail premises;
a digital camera configured to capture a facial image of a user entering a retail premises;
a network interface; and
a processor configured to identify the user entering the retail premises for a shopping session from a captured facial image,
the processor further configured retrieve shopping pattern data associated with an identified user, the shopping pattern data including data identifying products regularly purchased by the user and associated purchase intervals,
the processor further configured to determine whether the regularly purchased products are due for repurchase in accordance with associated purchase intervals,
the processor further configured to identify locations of regularly purchased products determined to be due for purchase in the retail premises in accordance with the map data, and
the processor further configured to generate image data depicting identified locations on a map of the retail premises.

2. The system of claim 1 wherein the processor is further configured to communicate generated image data for display on a portable data device associated with the user.

3. The system of claim 2 wherein the processor is further configured to:
receive new purchase data corresponding to products purchased by the user during the shopping session, and
update the shopping pattern data with received new purchase data.

4. The system of claim 1 wherein the memory stores coupon data corresponding to coupons or sales associated with previously purchased products, and wherein the processor is further configured to generate image data depicting the coupons or sales.

5. The system of claim 1 wherein the memory further stores secondary location map data corresponding to a layout of a second retail premises and product placement within the second retail premises, wherein the layout and product placement of the second retail premises is unique relative to layout and product placement of a prior shopping session associated with the user, and
wherein the processor is further configured to
identify locations of previously purchased products in the second retail premises from the secondary location map data, and
generate image data depicting identified locations of previously purchased products at the second retail premises.

6. The system of claim 1 wherein the memory stores updated map data corresponding to revised product placement within the retail premises, and
wherein the processor is further configured to
identify locations of previously purchased products in the retail premises in accordance with the updated map data, and
generate updated image data depicting identified locations on the map of the retail premises.

7. The system of claim 1 wherein the processor is further configured to generate the image data further identifying previously purchased items.

8. A method comprising:
storing map data corresponding to a layout of a retail premises and product placement within the retail premises;
capturing, with a digital camera, a facial image of a user entering the retail premises;
identifying the user from the captured facial image;
retrieving shopping pattern data associated with an identified user, the shopping pattern data including data identifying products regularly purchased by the user and associated purchase intervals;
determining whether the regularly purchased products are due for repurchase in accordance with associated purchase intervals;
identifying locations of regularly purchased products determined to be due for repurchase in the retail premises in accordance with the map data; and
generating image data depicting identified locations on a map of the retail premises.

9. The method of claim 8 further comprising communicating generated image data for display on a portable data device associated with the user.

10. The method of claim 9 further comprising:
receiving new purchase data corresponding to products purchased by the user during the shopping session; and
updating the shopping pattern data with received new purchase data.

11. The method of claim 8 further comprising retrieving coupon data corresponding to coupons or sales associated with previously purchase products, and wherein the processor is further configured to generate image data depicting the coupons or sales.

12. The method of claim 8 further comprising:
retrieving secondary location map data corresponding to a layout of a second retail premises and product placement within the second retail premises, wherein the layout and product placement of the second retail premises is unique relative to layout and product placement of a prior shopping session associated with the user,
identifying locations of previously purchased products in the second retail premises from the secondary location map data; and
generating image data depicting identified locations of previously purchased products at the second retail premises.

13. The method of claim 8 further comprising:
retrieving updated map data corresponding to revised product placement within the retail premises;
identifying locations of previously purchased products in the retail premises in accordance with the updated map data; and
generating updated image data depicting identified locations on a map of the retail premises.

14. The method of claim 8 further comprising generating the image data further identifying previously purchased items.

15. A system comprising:
memory storing, for each of a plurality of identified retail premises, map data corresponding to layout and product placement at each premises,
a plurality of retail premises, each retail premises including a digital camera configured to capture facial images of users entering its premises;
the memory further storing, for each of a plurality of users, contact information and facial image data stored associatively with shopping pattern data for that user;
a network interface configured for data communication with each retail premises, the data communication including receiving the facial images; and
a processor configured to identify a user and retail premises associated with each received facial image,
the processor further configured to, for each identified user and retail premises:
retrieve corresponding map data,
retrieve corresponding contact information,
retrieve corresponding shopping pattern data, the shopping data including data corresponding to regularly purchased products and purchase intervals associated with the regularly purchased products,
determine whether the regularly purchased products are due for repurchase in accordance with retrieved shopping pattern data,
identify locations of regularly purchased products determined to be due for repurchase in accordance with retrieved map data,
generate image data depicting identified locations on a map, and
communicate generated image data depicting identified locations on a map of the retail premises to the user in accordance with retrieved contact information.

16. The system of claim 15 wherein the processor is further configured to, for each identified user:
receive data corresponding to recently purchased products by the user,
generate updated shopping pattern data for the user in accord received data corresponding to recently purchased products, and
store updated shopping pattern data for the user.

17. The system of claim 16 wherein the processor is further configured to, for each identified retail premises:
receive modified map data associated with the premises,
generate updated map data from previously stored map data and modified map data, and
replace the previously stored map data with the updated map data.

18. The system of claim 15 wherein the memory further stores coupon data corresponding to products located at one or more of the retail premises, and wherein the processor is further configured to, for each identified user and retail premises:
retrieve coupon data corresponding to previously purchased items, and
generate the image data inclusive of image data associated with retrieved coupon data.

19. The system of claim 15 wherein the memory further stores on-sale data corresponding to on-sale products located at one or more of the retail premises, and wherein the processor is further configured to, for each identified user and retail premises:
retrieve on-sale data corresponding to previously purchased items, and
generate the image data inclusive of image data associated with retrieved on-sale data.

20. The system of claim 15 wherein the contact information includes one or more of a mobile phone number, email address or IP address associated with each identified user.
